(19) United States
(12) Patent Application Publication
(10) Pub. No.: US 2002/0199159 A1
(43) Pub. Date: Dec. 26, 2002

(54) Naked chip motherboard module

(76) Inventor: Vinson Dong, San Chong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/886,084

(22) Filed: Jun. 22, 2001

(51) Int. Cl. G06F 17/50

(52) U.S. Cl. 716/5

(57) ABSTRACT

This invention relates to a naked chip motherboard module, comprising a motherboard. The motherboard is a printed circuit board. The motherboard has a plurality of regional spaces, each regional space having a chip. All the chips can be recorded simultaneously to include functions or programs as required. Therefore, after the finished motherboard is cut in respective pieces, a plurality of chip modules can be obtained. Chip modules with high consistency can be obtained by speedy production.

### Background of the Invention

1. Field of the Invention

This invention relates to a naked chip motherboard module, particularly a module having a printed circuit board as a motherboard with such a mechanism that is capable of producing a plurality of chip modules simultaneously.

2. Background of the Invention

Chips are widely used in various applications. Many integrated circuits are designed in a single chip, saving significant amount of costs and production time. Therefore, many circuits are included in a single IC. After an IC chip is developed, however, it requires subsequent processes such as sealing and tests. Obviously there are some possibility for cost reduction. Therefore, some people have tried to directly install naked chips onto a printed circuit board to save the cost for subsequent processing of chips. But the processing time is lengthy for each single chip to be installed to each printed circuit board. There may even be significant errors or mistakes resulting in lower rate of satisfactory products. Furthermore, in case a chip is found defective after it has been installed on a printed circuit board in application, it would be very difficult to replace the chip. Sometimes, it may result in significant loss, if not permanent destruction, to the entire printed circuit board.

### BRIEF DESCRIPTION OF THE INVENTION

Therefore, the primary objective of this invention is to provide a naked chip motherboard module, involving a printed circuit board as its motherboard. The printed circuit board has several regional spaces to accommodate the chips, for the purpose of simultaneous production of identical chip modules. Several chip modules with high consistency can be obtained in such speedy production, after the finished motherboard is cut in separate pieces.

Another objective of this invention is to provide a naked chip motherboard module, wherein the chips on the motherboard can be recorded to include identical or different contents, to suit various application purposes.

A further objective of this invention is to provide a naked chip motherboard module, wherein each chip is joined to a smaller printed circuit board before it is joined to a larger printed circuit board that requires the chip module. In case a chip is found defective, the smaller circuit board carrying the defective chip can be removed directly in a convenient and easy process, without damaging the larger printed circuit board and the entire unit.

### BRIEF DESCRIPTION OF DRAWINGS

The drawings of preferred embodiments of this invention are described in following details to enable better understanding.

FIG. 1 is a view of the preferred embodiment of the invention, showing a plurality of chips installed on the motherboard.

FIG. 2 is an enlarge view of the invention, showing the chips installed on the motherboard, with connecting circuit in the space regions of the motherboard for direct connection with the circuit board in use.

### DETAILED DESCRIPTION OF PREFERRED EMBODIMENTS

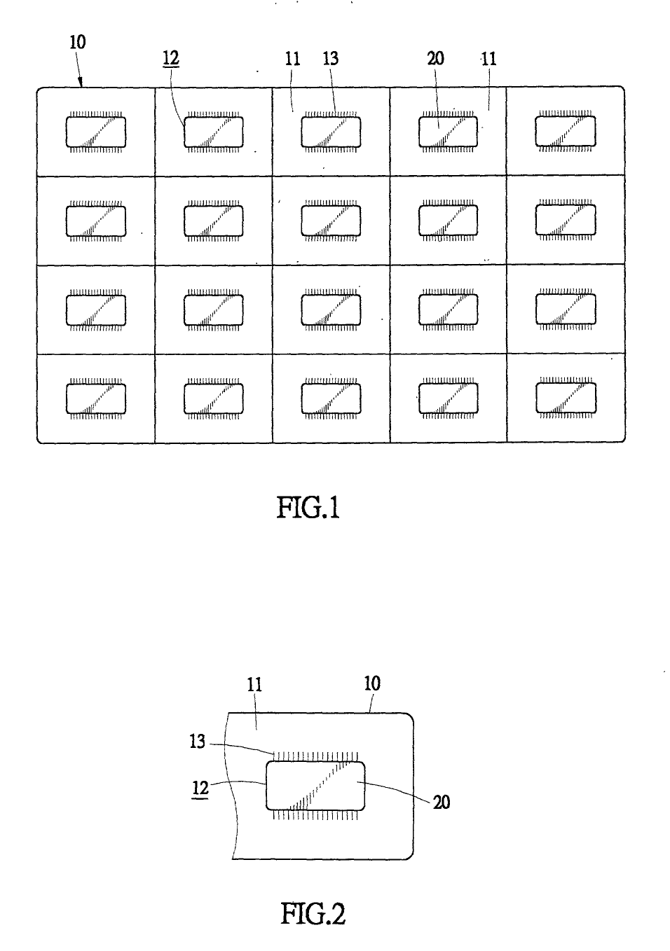

As shown in FIG. 1, a naked chip motherboard module of the present invention comprises a printed circuit board serving as a motherboard 10. The motherboard 10 has a plurality of regional spaces 11. Each regional space 11 has an accommodating chamber 12, each accommodating chamber 12 can accommodate one chip 20.

After the chips 20 are installed on the motherboard 10, the chips 20 are recorded to include functional circuits or programs as required. At this stage, the motherboard 10 has several chip modules. Reserved in each regional space 11 of the motherboard 10 are connecting pins 13 for the chip 20, so each chip module can be used directly after each regional space is cut and separated.

As far as the production process of the chip modules is concerned, since all chips are made under the same one environment, we can obtain chip modules with extremely high consistency. Furthermore, simultaneous recording of all chips has an edge over separate recording of individual chips. And, direct production of chip modules on the motherboard will avoid contamination during the process. On the whole, not only production speed can be increased, but also the rate of satisfactory products can be upgraded. The production costs can be effectively reduced, and its applicability and advance step can be affirmed. Since each chip has been joined in advance to a smaller printed circuit board, before it is joined to a larger printed circuit board that requires the chip module. Therefore, in case a chip module is found defective, even after it is already installed, we can directly remove the smaller circuit board carrying the chip in a convenient without destroying the larger printed circuit board and the entire unit.

What is claimed is:

1. A naked chip motherboard module, comprising a motherboard, said motherboard being a printed circuit board, on the motherboard having several regional spaces, each regional space having an accommodating chamber to accommodate a chip, with connecting pins for the chip in each regional space, so that after each chip is recorded and each regional space is cut and separated, a plurality of chip modules can be obtained for direct connection with circuit boards as required.
